(19) United States
(12) Patent Application Publication
(10) Pub. No.: US 2026/0012384 A1
(43) Pub. Date: Jan. 8, 2026

(54) CALIBRATION BETWEEN ACCESS POINTS IN A DISTRIBUTED MULTIPLE-INPUT MULTIPLE-OUTPUT NETWORK OPERATING IN TIME-DIVISION DUPLEXING MODE

(71) Applicant: Telefonaktiebolaget LM Ericsson (publ), Stockholm (SE)

(72) Inventors: Pål FRENGER, Linköping (SE); Joao VIEIRA, Hjärup (SE); Erik G. LARSSON, Linköping (SE)

(21) Appl. No.: 18/880,025

(22) PCT Filed: Jul. 4, 2022
(86) PCT No.: PCT/EP2022/068486

§ 371 Date: Dec. 30, 2024

(51) Int. Cl. H04L 27/26; H04B 7/0413; H04B 7/06; H04L 5/00

(52) U.S. Cl. CPC H04L 27/2656; H04B 7/0413; H04B 7/0617; H04L 5/0005; H04L 5/0044

(57) ABSTRACT

Techniques for transmitting and/or receiving calibration reference signals between APs in a D-MIMO network operating in TDD mode. A method includes transmitting, by a first AP and towards a second AP, a first calibration reference signal in a first uplink timeslot whilst the first AP refrains from receiving user data in the first uplink timeslot when transmitting the first calibration reference signal. Additionally or alternatively the method includes receiving, by a third AP and from a fourth AP, a second calibration reference signal in a first downlink timeslot whilst the third AP refrains from transmitting user data in the first downlink timeslot when receiving the second calibration reference signal.

The project leading to this application has received funding from the European Union's Horizon 2020 research and innovation programme under grant agreement No 101013425.

### TECHNICAL FIELD

Embodiments presented herein relate to transmission and/or reception of calibration reference signals between access points in a distributed multiple-input multiple-output network operating in time-division duplexing mode. Embodiments presented herein further relate to estimating a phase difference between the APs.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate for the physical layer of the 6^{th} generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

For robust, high throughput, communication, the preferred way of D-MIMO operation is in time-division duplexing (TDD), relying on reciprocity of the propagation channel between the serving APs and the served UE. Pilot signals transmitted by the UEs can thereby be used for the APs to simultaneously obtain the uplink channel response (i.e., the channel response for the radio channel from the UEs towards the APs) and the downlink channel response (i.e., the channel response for the radio channel from the APs towards the UEs). This type of TDD operation especially facilitates reciprocity-based beamforming in the downlink.

Ideally, the transceiver chain at each antenna in every AP would be synchronized to the same phase reference (or time reference; for a narrowband signal, a small time-shift is equivalent to a phase shift, and hence the terms phase reference and time reference can be used interchangeably). In an operating network, there will be phase errors that stem from differences in effective propagation path lengths in the uplink and downlink inside of the circuitry of the APs, from mismatches in sampling timing (due to lack of synchronization of inphase/quadrature (I/Q) mixers of different APs), etc. These phase errors are unknown a priori, and their collective effect can be described in terms of a phase offset tᵢ per transmitter chain (indexed by i) and a phase offset rᵢ for each receiver chain i. More specifically, consider a fictitious absolute phase reference (such as a global phasor that rotates at the speed ƒ_{c} revolutions per second). Define tᵢ to be the value of the local phasor of transmitter chain i when the global phasor points to zero; rᵢ similarly is defined as the value of the local phasor of receiver chain i when the global phasor is zero. Ideally, tᵢ=rᵢ=c, for some constant c but in an operating network (without calibration) this will not be the case, and hence tᵢ≠rᵢ, tᵢ≠tⱼ, etc.

Different approaches have been considered for compensating for such transceiver phase differences. One approach is to conduct over-the-air (OTA) measurements between pairs of AP antennas. This avoids the need for the APs to be provided with dedicated cables for calibration. This also avoids the need for involving the UEs in the calibration process.

In general terms, to keep the APs in a D-MIMO network phase aligned, multiple inter-AP calibration handshake transmissions (i.e., bi-directional or pairwise transmissions) are required, as noted in J. Vieira and E. G. Larsson, “Reciprocity calibration of Distributed Massive MIMO Access Points for Coherent Operation,” 2021 IEEE 32nd Annual International Symposium on Personal, Indoor and Mobile Radio Communications (PIMRC), 2021, pp. 783-787, doi: 10.1109/PIMRC50174.2021.9569495. One illustrative example is provided in FIGS. 1 and 2. In FIG. 1 is illustrated an example where two APs 200a, 200b is jointly serving a UE 130. Uplink and downlink transmissions are denoted “UL” and “DL”, respectively, and transmissions between the APs 200a, 200b for calibration purposes are denoted “HS”. In FIG. 2 is shown an example TDD pattern showing the timeslots reserved for UL, DL, and HS along a time axis. From FIG. 2 follows that, repeated (e.g. periodic or aperiodic) interruptions of the UL and DL transmissions are introduced during the calibration procedure. Although all timeslots are illustrated to have the same length, it is here noted that the duration of the HS timeslot does not need to be of the same duration as the UL and DL timeslots. For example, some UL and/or DL timeslots may be shortened to make room for the HS timeslots.

From FIG. 2 follows that the calibration procedure consumes radio resources (e.g., time) and disturbs the user-plane data flow, as defined by the UL and DL transmissions. During a HS timeslot, neither AP 200a nor AP 200b is transmitting data to the UE 130. Further, during a HS timeslot, neither AP 200a nor AP 200b is receiving data from the UE 130. The calibration procedure is wasteful in terms of radio resources and a more resource efficient calibration procedure would be beneficial. In addition, the calibration procedure incurs delays since some timeslots are dedicated to the calibration procedure. This can be an issue for delay-critical traffic.

In large-scale or dense deployments of D-MIMO networks more than two APs need to be calibrated with pairwise measurement handshakes. This results in that the calibration procedure consumes even more radio resources.

### SUMMARY

An object of embodiments herein is to address the above issues by enabling phase difference estimation between APs in a D-MIMO network operating in TDD mode without the need for dedicated handshake timeslots.

According to a first aspect there is presented a method for transmitting and/or receiving calibration reference signals between APs in a D-MIMO network operating in TDD mode. The method comprises transmitting, by a first AP and towards a second AP, a first calibration reference signal in a first uplink timeslot whilst the first AP refrains from receiving user data in the first uplink timeslot when transmitting the first calibration reference signal. Additionally or alternatively the method comprises receiving, by a third AP and from a fourth AP, a second calibration reference signal in a first downlink timeslot whilst the third AP refrains from transmitting user data in the first downlink timeslot when receiving the second calibration reference signal.

According to a second aspect there is presented an AP for transmitting and/or receiving calibration reference signals in a D-MIMO network operating in TDD mode. The AP comprises processing circuitry. The processing circuitry is configured to cause the AP to transmit, towards a second AP, a first calibration reference signal in a first uplink timeslot whilst refraining from receiving user data in the first uplink timeslot when transmitting the first calibration reference signal. Additionally or alternatively the processing circuitry is configured to cause the AP to receive, from a fourth AP, a second calibration reference signal in a first downlink timeslot whilst refraining from transmitting user data in the first downlink timeslot when receiving the second calibration reference signal.

According to a third aspect there is presented an AP for transmitting and/or receiving calibration reference signals in a D-MIMO network operating in TDD mode. The AP comprises a transmit module configured to transmit, towards a second AP, a first calibration reference signal in a first uplink timeslot whilst refraining from receiving user data in the first uplink timeslot when transmitting the first calibration reference signal. Additionally or alternatively the AP comprises a receive module configured to receive, from a fourth AP, a second calibration reference signal in a first downlink timeslot whilst refraining from transmitting user data in the first downlink timeslot when receiving the second calibration reference signal.

According to a fourth aspect there is presented a computer program for transmitting and/or receiving calibration reference signals in a D-MIMO network operating in TDD mode, the computer program comprising computer program code which, when run on processing circuitry of at least one AP, causes the at least one AP to perform a method according to the first aspect.

According to a fifth aspect there is presented a method for estimating a phase difference between APs in a D-MIMO network operating in TDD mode. The method is performed by a centralized node in the D-MIMO network. The method comprises instructing the APs to perform bi-directional sounding for the centralized node to obtain measurements on calibration reference signals by the APs wirelessly exchanging the calibration reference signals with each other. A first AP is instructed to transmit a first calibration reference signal in a first uplink timeslot towards a second AP and to refrain from receiving user data in the first uplink timeslot when transmitting the first calibration reference signal. Additionally or alternatively a third AP is instructed to receive a second calibration reference signal in a first downlink timeslot from a fourth AP and to refrain from transmitting user data in the first downlink timeslot when receiving the second calibration reference signal. The method comprises estimating the phase difference between the first AP and the second AP and/or between the third AP and the fourth AP from measurements made on the first calibration reference signal and/or on the second calibration reference signal.

According to a sixth aspect there is presented a centralized node for estimating a phase difference between APs in a D-MIMO network operating in TDD mode. The centralized node comprises processing circuitry. The processing circuitry is configured to cause the centralized node to instruct the APs to perform bi-directional sounding for the centralized node to obtain measurements on calibration reference signals by the APs wirelessly exchanging the calibration reference signals with each other. A first AP is instructed to transmit a first calibration reference signal in a first uplink timeslot towards a second AP and to refrain from receiving user data in the first uplink timeslot when transmitting the first calibration reference signal. Additionally or alternatively a third AP is instructed to receive a second calibration reference signal in a first downlink timeslot from a fourth AP and to refrain from transmitting user data in the first downlink timeslot when receiving the second calibration reference signal. The processing circuitry is configured to cause the centralized node to estimate the phase difference between the first AP and the second AP and/or between the third AP and the fourth AP from measurements made on the first calibration reference signal and/or on the second calibration reference signal.

According to a seventh aspect there is presented a centralized node for estimating a phase difference between APs in a D-MIMO network operating in TDD mode. The centralized node comprises an instruct module configured to instruct the APs to perform bi-directional sounding for the centralized node to obtain measurements on calibration reference signals by the APs wirelessly exchanging the calibration reference signals with each other. A first AP is instructed to transmit a first calibration reference signal in a first uplink timeslot towards a second AP and to refrain from receiving user data in the first uplink timeslot when transmitting the first calibration reference signal. Additionally or alternatively a third AP is instructed to receive a second calibration reference signal in a first downlink timeslot from a fourth AP and to refrain from transmitting user data in the first downlink timeslot when receiving the second calibration reference signal. The centralized node comprises an estimate module configured to estimate the phase difference between the first AP and the second AP and/or between the third AP and the fourth AP from measurements made on the first calibration reference signal and/or on the second calibration reference signal.

According to an eighth aspect there is presented a computer program for estimating a phase difference between APs in a D-MIMO network operating in TDD mode, the computer program comprising computer program code which, when run on processing circuitry of a centralized node, causes the centralized node to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

According to a tenth aspect there is provided a system comprising a centralized node according to the sixth or seventh aspect and at least one AP according to the second or third aspect.

Advantageously, these aspects enable phase difference estimation between APs in a D-MIMO network operating in TDD mode without the need for dedicated handshake timeslots.

Advantageously, these aspects improve the utilization of available radio resources.

Advantageously, these aspects do not require any dedicated transmission gaps for transmission and reception of the calibration reference signals is required. Hence, the radio channel can still be utilized for data transmission during the entire calibration procedure. Hence, these aspects do not disrupt UL and DL data flows due to calibration handshakes as in the example in FIGS. 1 and 2.

Advantageously, these aspects reduce the latency of UL and DL transmissions compared to the example in FIGS. 1 and 2.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic illustration of a communication network according to an example;

FIG. 2 is a schematic illustration of UL, DL, and HS timeslots for a calibration procedure in the communication network of FIG. 1;

FIG. 3 is a schematic diagram illustrating a communication network according to embodiments;

FIGS. 4 and 5 are flowcharts of methods according to embodiments;

FIG. 6 is a schematic illustration of two APs and a UE where a calibration procedure is performed according to embodiments;

FIG. 7 is a signalling diagram according to an embodiment;

FIG. 8 is a schematic diagram showing functional units of an AP according to an embodiment;

FIG. 9 is a schematic diagram showing functional modules of an AP according to an embodiment;

FIG. 10 is a schematic diagram showing functional units of a centralized node according to an embodiment;

FIG. 11 is a schematic diagram showing functional modules of a centralized node according to an embodiment;

FIG. 12 shows one example of a computer program product comprising computer readable means according to an embodiment;

FIG. 13 is a schematic diagram illustrating a telecommunication network connected via an intermediate network to a host computer in accordance with some embodiments; and

FIG. 14 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

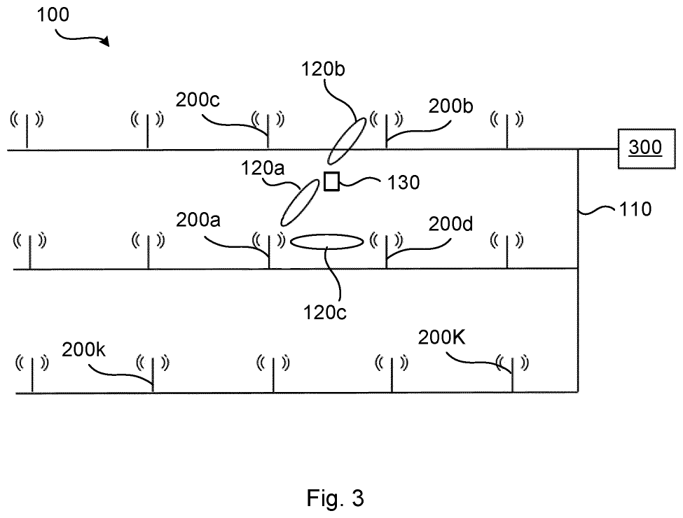

FIG. 3 is a schematic diagram illustrating a communication network 100 where embodiments presented herein can be applied. The communication network 100 comprises K APs, six of which are identified at reference numerals 200a, 200b, 200c, 200d, 200k, 200K. In this respect, the herein disclosed embodiments are not limited to any particular number of APs 200a: 200K as long as there are at least two APs 200a: 200K. Each AP 200a: 200K could be a (radio) access network node, radio base station, base transceiver station, node B (NB), evolved node B (eNB), gNB, integrated access and backhaul (IAB) node, one or more distributed antenna, or the like. The APs 200a: 200K operatively connected over interfaces 110 to a centralized node 300, which could represent an interface to a core network. The centralized node 300 could be a (radio) base station, or the like. The APs 200a: 200K are configured to provide network access to user equipment (UE) 130. Each such UE 130 could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like. Each such UE 130 is configured for wireless communication with the APs 200a: 200K. In some examples, the APs 200a: 200K use beamforming for this communication, as represented by beams 120a, 120b, 120c. In some aspects, the communications network 100 is a D-MIMO network. Hence, in some examples, the APs 200a: 200K are part of a D-MIMO network.

In general terms, transmissions of, and measurements on, calibration reference signals are performed during normal TDD UL and DL timeslots, without disturbing the flow of data to and from the UEs 130.

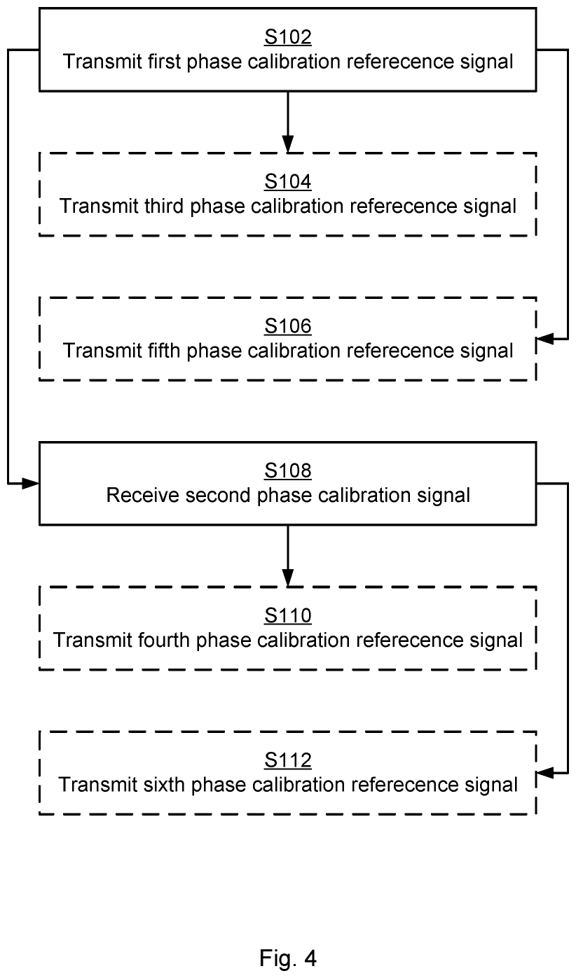

Reference is now made to FIG. 4 illustrating a method for transmitting and/or receiving calibration reference signals between APs 200a: 200K in a D-MIMO network 100 operating in TDD mode according to an embodiment.

S102: A first AP 200a transmits, towards a second AP 200b, a first calibration reference signal in a first uplink timeslot whilst the first AP 200a refrains from receiving user data in the first uplink timeslot when transmitting the first calibration reference signal.

That is, during a TDD uplink timeslot a first AP 200a transmits a first calibration reference signal for AP phase alignment and refrains from participating in the reception of UL user data from any UE 130. In the same TDD uplink timeslot a second AP 200b receives both the first calibration reference signal and uplink user data from the UE 130.

S108: A third AP 200c receives, from a fourth AP 200d, a second calibration reference signal in a first downlink timeslot whilst the third AP 200c refrains from transmitting user data in the first downlink timeslot when receiving the second calibration reference signal.

That is, during a TDD downlink timeslot, a fourth AP 200d might transmit both downlink user data towards the UE 130 and a second calibration reference signal for AP phase alignment. In the same TDD downlink timeslot, a third AP 200c receives the second calibration reference signal and refrains from participating in transmission of the downlink user data towards the UE 130.

Advantageously, this method enables phase difference estimation between the APs 200a: 200K in a D-MIMO network 100 operating in TDD mode without the need for dedicated handshake timeslots.

Advantageously, this method improves the utilization of available radio resources.

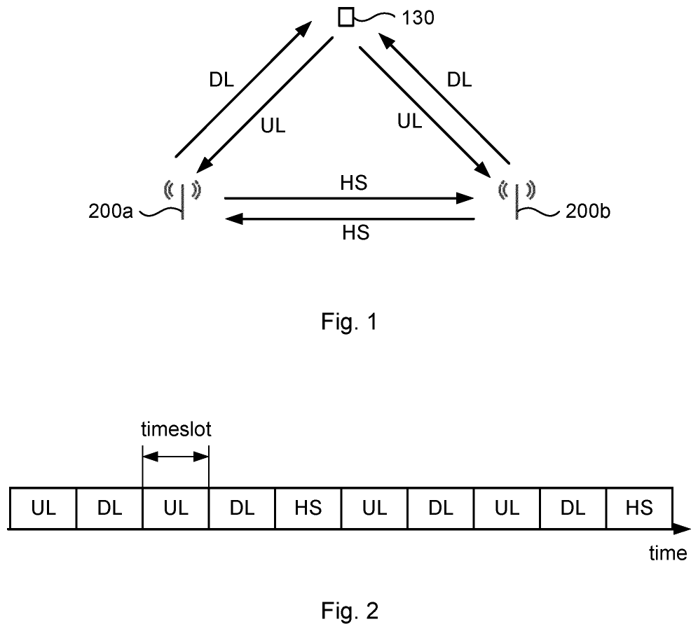

Advantageously, this method does not require any dedicated transmission gaps for transmission and reception of the calibration reference signals is required. Hence, the radio channel can still be utilized for data transmission during the entire calibration procedure. Hence, this method does not disrupt UL and DL data flows due to calibration handshakes as in the example in FIGS. 1 and 2.

Advantageously, this method reduces the latency of UL and DL transmissions compared to the example in FIGS. 1 and 2.

Embodiments relating to further details of transmitting and/or receiving calibration reference signals between APs 200a: 200K in a D-MIMO network 100 operating in TDD mode will now be disclosed.

As disclosed above, the first AP 200a transmits a first calibration reference signal towards the second AP 200b in a first uplink timeslot. There might be different ways in which the second AP 200b might transmit a reference signal towards the first AP 200a.

According to a first example, in the next downlink timeslot, the second AP 200b transmits a calibration reference signal towards the first AP 200a. Thus, according to some embodiments, S104 is performed.

S104: The second AP 200b transmits a third calibration reference signal towards the first AP 200a and user data towards user equipment 130 served in the D-MIMO network 100 in a second downlink timeslot following the first uplink timeslot.

According to a second example, in the same uplink timeslot, the second AP 200b transmits a calibration reference signal towards the first AP 200a. Thus, according to some embodiments, S106 is performed.

S106: The second AP 200b transmits, towards the first AP 200a, a fifth calibration reference signal in the first uplink timeslot whilst the second AP 200b refrains from receiving user data in the first uplink timeslot when transmitting the third calibration reference signal.

Steps S104 and S106 might thus be regarded as alternatives to each other.

As further disclosed above, the third AP 200c receives a second calibration reference signal from the fourth AP 200d in a first downlink timeslot. There might be different ways in which the third AP 200c might transmit a reference signal towards fourth AP 200d.

According to a first example, in the next uplink timeslot, the third AP 200c transmits a calibration reference signal towards the fourth AP 200d. Thus, according to some embodiments, S110 is performed.

S110: The third AP 200c transmits, towards the fourth AP 200d, a fourth calibration reference signal in a second uplink timeslot following the first downlink timeslot whilst the third AP 200c refrains from receiving user data in the second uplink timeslot when transmitting the fifth calibration reference signal.

According to a second example, in the same downlink timeslot, the third AP 200c transmits a calibration reference signal towards the fourth AP 200d. Thus, according to some embodiments, S112 is performed.

S112: The third AP 200c transmits, by the third AP 200c, a sixth calibration reference signal towards the fourth AP 200d and user data towards user equipment 130 served in the D-MIMO network 100 in the first downlink timeslot.

Steps S110 and S112 might thus be regarded as alternatives to each other.

In some embodiments, the first AP 200a and the third AP 200c is one and the same AP, and the third AP 200c and the fourth AP 200d is one and the same AP.

The calibration reference signal and the user data might, when transmitted in the same downlink timeslot be beamformed differently so that the user data reaches the served user equipment 130 and the calibration reference signal reaches its intended receiving AP without causing interference to the served user equipment 130. Therefore, in some embodiments, the third calibration reference signal and the user data are beamformed differently, and/or the fourth calibration reference signal and the user data are beamformed differently.

The calibration reference signal and the user data might, when transmitted in the same downlink timeslot, either be transmitted in the same time/frequency resources or in different time/frequency resources within the same time/frequency grid. Hence, in some embodiments, the third calibration reference signal and the user data are transmitted in the same time/frequency resources, and/or the fourth calibration reference signal and the user data are transmitted in the same time/frequency resources. In other embodiments the third calibration reference signal and the user data are transmitted in different time/frequency resources within the same time/frequency grid, and/or the fourth calibration reference signal and the user data are transmitted in different time/frequency resources within the same time/frequency grid.

Further, there might be different ways for an AP to in the same uplink timeslot receive both a calibration reference signal and user data.

According to a first example, in the first uplink timeslot the second AP 200b receives the first calibration reference signal as well as user data from user equipment 130 served by the second AP 200b, and wherein the first calibration reference signal and the user data are spatially multiplexed at the second AP 200b.

According to a second example, in the first uplink timeslot the first AP 200a receives the third calibration reference signal as well as user data from user equipment 130 served by the first AP 200a, and wherein the third calibration reference signal and the user data are spatially multiplexed at the first AP 200a, and/or

According to a third example, in the second uplink timeslot the fourth AP 200d receives the fourth calibration reference signal as well as user data from user equipment 130 served by the fourth AP 200d, and wherein the fourth calibration reference signal and the user data are spatially multiplexed at the fourth AP 200d.

In some embodiments, the respective calibration reference signals are transmitted and processed upon the APs 200a: 200K having received instructions from a centralized node 300 in the D-MIMO network 100 to do so. Further aspects of this will be disclosed next.

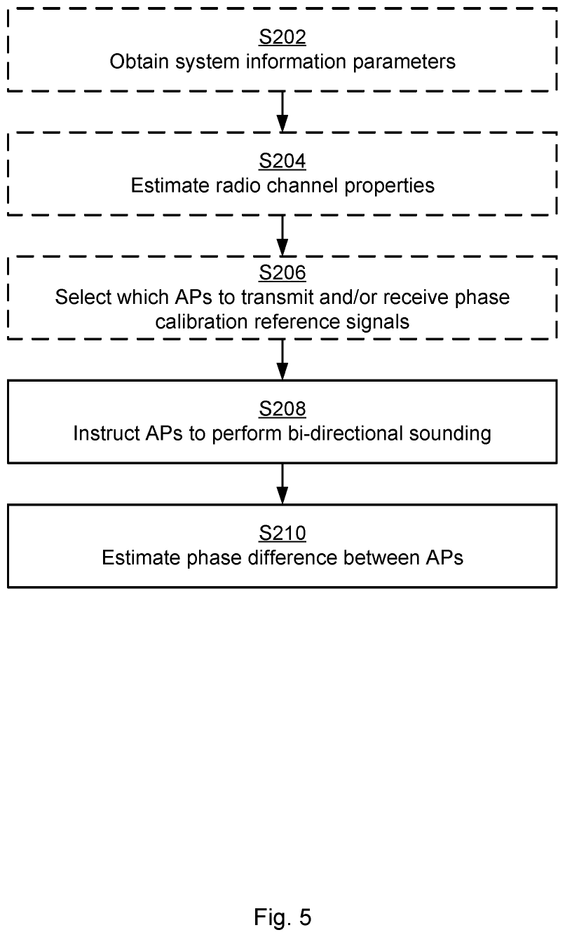

Reference is now made to FIG. 5 illustrating a method for estimating a phase difference between APs 200a: 200K in a D-MIMO network 100 operating in TDD mode as performed by the centralized node 300 according to an embodiment.

S208: The centralized node 300 instructing S208 the APs 200a: 200K to perform bi-directional sounding for the centralized node 300 to obtain measurements on calibration reference signals by the APs 200a: 200K wirelessly exchanging the calibration reference signals with each other.

A first AP 200a is instructed to transmit a first calibration reference signal in a first uplink timeslot towards a second AP 200b and to refrain from receiving user data in the first uplink timeslot when transmitting the first calibration reference signal (as in S102). Additionally or alternatively, a third AP 200c is instructed to receive a second calibration reference signal in a first downlink timeslot from a fourth AP 200d and to refrain from transmitting user data in the first downlink timeslot when receiving the second calibration reference signal (as in S108).

S210: The centralized node 300 estimates the phase difference between the first AP 200a and the second AP 200b from measurements made on the first calibration reference signal and/or the phase difference between the third AP 200c and the fourth AP 200d from measurements made on the second calibration reference signal.

Advantageously, this method provides phase difference estimation between the APs 200a: 200K in a D-MIMO network 100 operating in TDD mode without the need for dedicated handshake timeslots.

Advantageously, this method improves the utilization of available radio resources.

Advantageously, this method does not require any dedicated transmission gaps for transmission and reception of the calibration reference signals is required. Hence, the radio channel can still be utilized for data transmission during the entire calibration procedure. Hence, this method does not disrupt UL and DL data flows due to calibration handshakes as in the example in FIGS. 1 and 2.

Advantageously, this method reduces the latency of UL and DL transmissions compared to the example in FIGS. 1 and 2.

Embodiments relating to further details of estimating a phase difference between APs 200a: 200K in a D-MIMO network 100 operating in TDD mode as performed by the centralized node 300 will now be disclosed.

As above, the second AP 200b might be instructed to transmit a third calibration reference signal towards the first AP 200a and user data towards user equipment 130 served in the D-MIMO network 100 in a second downlink timeslot following the first uplink timeslot.

As above, the second AP 200b might be instructed to transmit a fifth calibration reference signal towards the first AP 200a in the first uplink timeslot whilst the second AP 200b refrains from receiving user data in the first uplink timeslot when transmitting the third calibration reference signal.

As above, the third AP 200c might be instructed to transmit a fourth calibration reference signal towards the fourth AP 200d in a second uplink timeslot following the first downlink timeslot whilst the third AP 200c refrains from receiving user data in the second uplink timeslot when transmitting the fifth calibration reference signal.

As above, the third AP 200c might be instructed to transmit a sixth calibration reference signal towards the fourth AP 200d and user data towards user equipment 130 served in the D-MIMO network 100 in the first downlink timeslot.

As above, in some embodiments, the first AP 200a and the third AP 200c is one and the same AP, and the third AP 200c and the fourth AP 200d is one and the same AP.

In some examples, the selection of which of the APs 200a: 200K to transmit calibration reference signals and which of the APs 200a: 200K to receive calibration reference signals in the uplink and downlink timeslots is done in on-the-fly based on radio channel properties and system state parameters, in order to minimize the impact of running the calibration protocol during the uplink and downlink timeslots. In some aspects, between which of the APs 200a: 200K the calibration reference signals is to be transmitted is thus based on system state parameters. Therefore, in some embodiments, the centralized node 300 is configured to perform (optional) step S202.

S202: The centralized node 300 obtains system state parameters for the APs 200a: 200K.

Between which of the APs 200a: 200K the first calibration reference signal is to be transmitted and/or between which of the APs 200a: 200K the second calibration reference signal is to be transmitted can then be determined as a function of the system state parameters. In some non-limiting examples, this function is a utility function, as will eb disclosed in further detail below.

In some non-limiting examples, the system state parameters pertain to any, or any combination of: traffic situation per each of the APs 200a: 200K, phase calibration between pairs of the APs 200a: 200K, channel state information per each of the APs 200a: 200K, and modulation and coding scheme used per each of the APs 200a: 200K.

In some aspects, knowledge of radio channel properties between the APs 200a: 200K and user equipment 130 served by the APs 200a: 200K is used for determining which of the APs 200a: 200K to transmit calibration reference signals and which of the APs 200a: 200K to receive calibration reference signals in the uplink and downlink timeslots. Therefore, in some embodiments, the centralized node 300 is configured to perform (optional) steps S204 and S206.

S204: The centralized node 300 estimates radio channel properties between the APs 200a: 200K and user equipment 130 served by the APs 200a: 200K.

S206: The centralized node 300 selects which of the APs 200a: 200K to transmit the first calibration reference signal and/or which of the APs 200a: 200K to receive the second calibration reference signal as a function of the radio channel properties.

Further aspects of how the knowledge of radio channel properties between the APs 200a: 200K and user equipment 130 served by the APs 200a: 200K is used for determining which of the APs 200a: 200K to transmit calibration reference signals and which of the APs 200a: 200K to receive calibration reference signals in the uplink and downlink slots. Here, the radio channel properties relate to channel quality between the APs 200a: 200K and the user equipment 130 served in the D-MIMO network 100.

In some aspects, the AP with best channel quality towards the user equipment 130 is selected to transmit a calibration reference signal in a downlink timeslot. This enables this AP to continuing serving the user equipment 130 in the downlink. In particular, in some embodiments, which of the APs 200a: 200K to be instructed to transmit the third calibration reference signal in the second downlink timeslot is by the centralized node 300 selected as the AP 200b with highest channel quality towards user equipment 130 served in the D-MIMO network 100.

In some aspects, the AP with worst channel quality towards the user equipment 130 is selected to transmit the calibration reference signal in an uplink timeslot. This enables the best AP to continue serving the user equipment 130 in the uplink timeslot. In particular, in some embodiments, which of the APs 200a: 200K to be instructed to transmit the first calibration reference signal in the first uplink timeslot is by the centralized node 300 selected as the AP 200a with lowest channel quality towards user equipment 130 served in the D-MIMO network 100.

These two embodiments imply that when the synchronization procedure is performed first in an uplink timeslot and then in the directly following downlink timeslot (or first in a downlink timeslot and then the directly following uplink timeslot), the AP with best channel quality is receiving a calibration reference signal in an uplink timeslot and transmitting a calibration reference signal in a downlink timeslot, and the AP with worst channel quality is transmitting a calibration reference signal in the uplink timeslot and receiving a calibration reference signal in the downlink timeslot.

In some aspects, any AP with bad channel quality towards a served user equipment 130 is selected to receive a calibration reference signal in a downlink timeslot. When receiving a calibration reference signal this AP cannot participate in downlink transmission of user data. In particular, in some embodiments, which of the APs 200a: 200K to be instructed to receive the second calibration reference signal in the first downlink timeslot is by the centralized node 300 selected as one of the APs 200c with a channel quality below a threshold value towards user equipment 130 served in the D-MIMO network 100.

In some aspects, any AP with bad channel quality towards a served user equipment 130 is selected to transmit a calibration reference signal in an uplink subframe. When transmitting a calibration reference signal this AP cannot participate in uplink reception of user data. In particular, in some embodiments, which of the APs 200a: 200K to be instructed to transmit the first calibration reference signal in the first uplink timeslot is by the centralized node 300 selected as one of the APs 200a with a channel quality below a threshold value towards user equipment 130 served in the D-MIMO network 100.

These two embodiments concern utilizing occasions when a dip in a fast-fading channel makes one AP temporarily experiencing bad channel quality. Assuming that there is a temporary dip in channel quality, increasing the downlink or uplink SINR will not improve the channel quality for this AP. This makes it instead possible to utilize this AP for transmission of a calibration reference signal in an uplink timeslot and/or for transmission of a calibration reference signal in a downlink timeslot.

It is further understood that idle uplink and/or downlink timeslots (i.e., timeslots for which there is not any user data to be transmitted from/to the served user equipment 130) might also in an opportunistic fashion be used for transmission (and reception) of calibration reference signals between the APs 200a: 200K, possible between different subsets of APs 200a: 200K in different idle uplink and/or downlink timeslots.

Scheduling of the data traffic might be performed jointly with the scheduling of calibration reference signals for the phase calibration procedure. In particularly, according to some embodiments, between which of the APs 200a: 200K the first calibration reference signal is to be transmitted and/or between which of the APs 200a: 200K the second calibration reference signal is to be transmitted is jointly determined together with determining scheduling of user data traffic for the APs 200a: 200K.

Further aspects of transmitting and/or receiving calibration reference signals between APs 200a: 200K and further details of estimating a phase difference between APs 200a: 200K in a D-MIMO network 100 operating in TDD mode will now be disclosed.

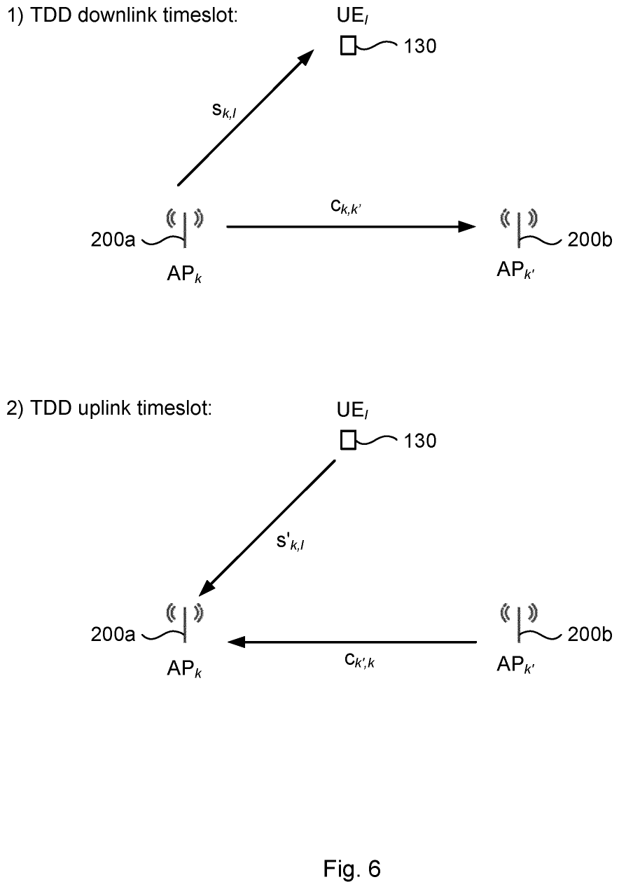

Assume that the K APs in FIG. 3 are denoted APₖ where k=1, . . . , K and that the K APs serve L UEs (l=1, . . . , L). For simplicity of disclosure, but without loss of generality, it is assumed that there are two APs (APₖ and AP_{k′}) and one UE (UEₗ), as depicted in FIG. 6.

In the example given in FIG. 6 it is assumed that the calibration procedure is started by APₖ transmitting a calibration reference signal in a TDD downlink timeslot. In the TDD downlink timeslot, APₖ transmits downlink user data to all UEs that it serves (i.e., a subset of all UEs served by the D-MIMO network 100). In the FIG. 6 only UE, is depicted and hence only a downlink user data signal s_{k,l} is explicitly shown. In addition, APₖ transmits a calibration reference signal c_{k,k′} targeting AP_{k′}. Note that AP_{k′} is configured to receive the calibration reference signal c_{k,k′}, and hence it cannot simultaneously transmit any downlink user data signal s_{k,l} to UEₗ (or to any other UE). Simultaneous transmission and reception would require that the APs have full-duplex capabilities which is not assumed here.

In the subsequent TDD uplink timeslot, the calibration procedure is completed by AP_{k′} transmitting a calibration reference signal c_{k′,k} back to APₖ. AP_{k′} cannot receive any uplink user data signal denoted s′_{k,l} from the UE whilst AP_{k′} is transmitting the calibration reference signal c_{k′,k}. This is since the APs are assumed to not be enabled for simultaneous transmission and reception.

In some examples, the calibration reference signal (c_{k,k′}) and the downlink user data signal (s_{k,l}) are beamformed differently. For example, the calibration reference signal (c_{k,k′}) might be beamformed towards AP_{k′} whilst the user data signal (s_{k,l}) is beamformed towards UEₗ. This enables the transmission of the calibration reference signal c_{k,k′} and of the user data signal s_{k,l} to occur in the same time/frequency (T/F) grid resources, rather than in distinct T/F grid resources.

That the transmission of the calibration reference signal c_{k,k′} and of the user data signal s_{k,l} occur in the same T/F grid resources may be the case if the receiving AP, AP_{k′}, can distinguish the calibration reference signal c_{k,k′} from the downlink user data signal s_{k,l} with high enough accuracy. One way to achieve this is, for example, if the channel response from APₖ to the UEₗ is very different from the channel response from APₖ to AP_{k′}, such that APₖ can beamform the calibration reference signal (c_{k,k′}) towards AP_{k′} whilst the user data signal (s_{k,l}) is beamformed towards UEₗ. Both signals should then be received with low interference.

That the transmission of the calibration reference signal c_{k,k′} and of the user data signal s_{k,l} occur in distinct T/F grid resources may be the case if the channel response from APₖ to UEₗ is very similar to the channel response from APₖ to AP_{k′}. This could, for example, be the case if UE is in line-of-sight from APₖ in a direction close to the direction towards AP_{k′}. In such a case, the calibration reference signal and the downlink user data signal might be be transmitted on different resource elements (such as on orthogonal frequency resources).

A similar logic applies when instead the calibration reference signal (c_{k′,k}) is transmitted from AP_{k′} and UEₗ transmits the uplink user data signal (c_{k,k′}). The requirement for simultaneously transmission of the calibration reference signal and the uplink user data signal is that APₖ should be able to spatially multiplex the two signals via, e.g., receive beamforming. In one example, the beamformer associated with the transmissions and reception by APₖ is computed based on previous handshake measurement instances (between APₖ and AP_{k′}) and/or by a previous interaction with AP_{k′} and a UE outside of the calibration protocol. One instance of such beamforming computation is if APₖ has access to a previous calibration measurement c_{k′,k} as well a previous measurement on uplink user data signals, and is capable of executing reciprocity-based beamforming locally.

With the example described so far, UE is served by a subset of two APs (APₖ and APₖ). During a calibration procedure one of the serving APs (in this example AP_{k′}) is temporarily removed from the serving set of APs. It is here noted that in general terms, different UEs can have different sets of serving APs in a D-MIMO network.

To minimize the performance degradation when temporarily removing one AP from the set of serving APs to facilitate calibration measurements, it might matter form which AP the calibration reference signal first is transmitted and if the calibration procedure starts in an UL or a DL timeslot. Any AP transmitting a calibration reference signal in a DL timeslot can also participate in transmission of downlink user data towards the UEs. Further, any AP receiving a calibration reference signal in an UL timeslot can also participate in receiving uplink user data from the UE.

Referring again to FIG. 6, it is noted that if the calibration procedure begins in a DL timeslot, then the AP that transmits the first calibration reference signal can serve the UE both in that DL timeslot and in the subsequent UL timeslot. On the other hand, the AP receiving the first calibration reference signal and transmitting the second calibration reference signal can neither serve the UE in the corresponding DL timeslot nor in the corresponding UL timeslot. Knowledge of the channel gains/path losses between the served UE and the serving APs might therefore be useful when determining from which AP the first calibration reference signal should be transmitted. In the example of FIG. 6, it can be assumed that APₖ has better channel gain towards UEₗ than AP_{k′} has.

In some examples, the calibration procedure is initiated in an UL timeslot. In such examples the AP which transmits the calibration reference signal in the UL timeslot should preferably be the AP having the worst channel gain towards the UE.

The selection of a pair of APs that should perform a calibration procedure might be based on several system state parameters.

In some examples, the calibration procedure is based on the traffic situation.

In a first example, the traffic situation is assumed to be low. An AP that is idle all the time does not need to be calibrated. However, if an AP is temporarily idle in a timeslot, then this AP could be selected for performing a calibration procedure with some other AP. Performing a calibration procedure with an AP that is temporarily idle minimizes the impact in terms of AP-to-UE re-associations as well as link performance variations.

In a second example, the traffic situation is assumed to be high An AP that is constantly active e.g., serving multiple UEs with high data rates and/or high priority traffic, is more sensitive to performance degradations due to calibration errors. Hence, highly active APs need to maintain a higher degree of calibration accuracy and could therefore be selected to perform a calibration procedure more often than other APs.

In some examples, the calibration procedure is based on the current calibration quality. In general terms, the calibration accuracy degrades with time. APs that have not performed a calibration procedure for a long time (depending on the stability of the hardware at hand) can be assumed to be poorly calibrated and for that reason be selected to perform a calibration procedure. Calibration accuracy and stability may also differ from one AP to another AP due to e.g., differences in oscillator quality, temperature, phase noise levels, etc.

In some examples, the calibration procedure is based on channel state information. As noted above, channel state information (e.g., representing the channel gain between the AP and a served UE) may impact if an AP shall perform a calibration procedure or not.

For example, if an AP is engaged in serving a UE with a very high path loss, then the AP may not have any additionally available transmit power to spend on sending a calibration reference signal in the same timeslot.

In some examples, the calibration procedure is based on the modulation level used for transmission of the user data. APs that only serve UEs with a relatively low modulation (e.g., quadrature phase shift keying (QPSK)) might tolerate a higher calibration error than APs that serve UEs with a higher modulation orders (e.g. 64 quadrature amplitude modulation (QAM)). APs using high-order modulation schemes might therefore need to perform calibration procedures more often than other APs.

One way to combine several such different types of information parameters is to calculate a utility metric related to the cost of calibration for each AP. The cost of calibration can e.g., be calculated as a weighted sum of estimates of different units (e.g. loss of UL signal to interference plus noise ratio (SINR) loss of DL SINR). The weighing factors might be selected e.g., through experimentation or by using machine learning (ML) techniques.

In general terms, the cost of calibration can be expressed as a function ƒ(·) of a set of variables x₁, . . . , x_{c} which quantify/measure any of the above described system state parameters for a current time instance. The cost of performing the calibration procedure for a given timeslot is given by Cost=ƒ(x₁, . . . , x_{c}). A practical function may be a linear combination of the variables:

$$Cost = {α}_{1} {x}_{1} + … + {α}_{c} {x}_{c}$$

where weighting parameters α₁, . . . , α_{c} are used to prioritize the importance of the different variables x₁, . . . , x_{c}. A scaling function might be applied to the variables x₁, . . . , x_{c} prior to the weighing parameters α₁, . . . , α_{c} being applied. Any type of variable scaling technique (sometimes referred to as feature scaling) can be applied to the variables x₁, . . . , x_{c} to ensure that variables with different properties (such as minimum value, maximum value, mean value, variance, distribution, etc.) can be efficiently combined into a cost function. Non-limiting examples of such scaling are “min-max scaling” where the scaled variables, denoted,

$${x}_{i}^{scaled} ,$$

are found as

$${x}_{i}^{scaled} = \frac{{x}_{i} - min ( {x}_{i} )}{max ( {x}_{i} ) - min ( {x}_{i} )} ,$$

where min(xᵢ) is the minimum of all xᵢ, and max(xᵢ) is the maximum of all xᵢ. and “standard scaling” where the scaled variables are found as

$${x}_{i}^{scaled} = \frac{{x}_{i} - mean ( {x}_{i} )}{std ( {x}_{i} )} ,$$

Where mean (xᵢ) is the mean value of all xᵢ, and std (xᵢ) is the standard deviation of all xᵢ.

In some examples, all weighing parameters α₁, . . . , α_{c} are initially set to be equal, e.g. αᵢ=1. If one variable is considered to be more important than others, then the scaling factors for the corresponding variables may be increased or decreased accordingly. This fine-tuning of the weighing parameters α₁, . . . , α_{c} might be based on subjective considerations. In addition, the potential reward from performing the calibration procedure can be calculated in a similar manner using a function g(·) of different expected benefits y₁, . . . , yᵣ with corresponding weighting parameters β₁, . . . , βᵣ:

$$Reward = {β}_{1} {y}_{1} + … + {β}_{r} {y}_{r}$$

Also here, applying standard variable scaling techniques is recommended. A reward metric for the expected calibration reward may consist of a linear combination of e.g. the expected UL/DL SINR improvement due to reduced calibration error, the current calibration accuracy requirement, etc.

The calibration cost estimate and the calibration reward estimate may also be combined to a calibration priority utility metric for each AP:

$$Utility = Reward - Cost$$

An AP can e.g., be selected for performing a calibration procedure when the calibration utility metric exceeds a threshold. Alternatively, among the set of APs serving the same UE, the pair of APs with the largest calibration priority can be selected to perform a calibration procedure. Expressed differently, the centralized node 300 might track one (or more) calibration utility metric for at least one AP, and activate a calibration procedure when at least one calibration utility metric exceeds a threshold.

In some examples, the scheduling of user data traffic is done jointly with the scheduling of the calibration procedure signaling transmissions. This enables the scheduler to delay low priority traffic in order to create opportunities for performing the calibration procedure. This also results in a possible reduction of the bitrate to the served UEs that are affected by a possible reduction of UL and DL SINR when the calibration procedure is performed.

In case there is a subset composed of more than two APs that jointly serve the same UE then this subset of APs should be jointly calibrated. One way to achieve this is to select one AP in the subset to be a calibration reference AP. The remaining APs in the subset can then be calibrated with respect to the calibration reference AP. In some examples, the calibration reference AP is the AP with the largest path gain towards the served UE. In other examples, the calibration reference AP is selected as the AP having the best radio channels for calibration (e.g., the radio channels with largest path gains to as many as possible of the other APs in the subset of APs serving the UE). The calibration reference AP then performs multiple calibration procedures, one with each off the remaining APs in the subset. It is also possible to perform more than one calibration procedure with more than one pair of APs in one pair of UL/DL timeslots by using multiple calibration reference signals in parallel.

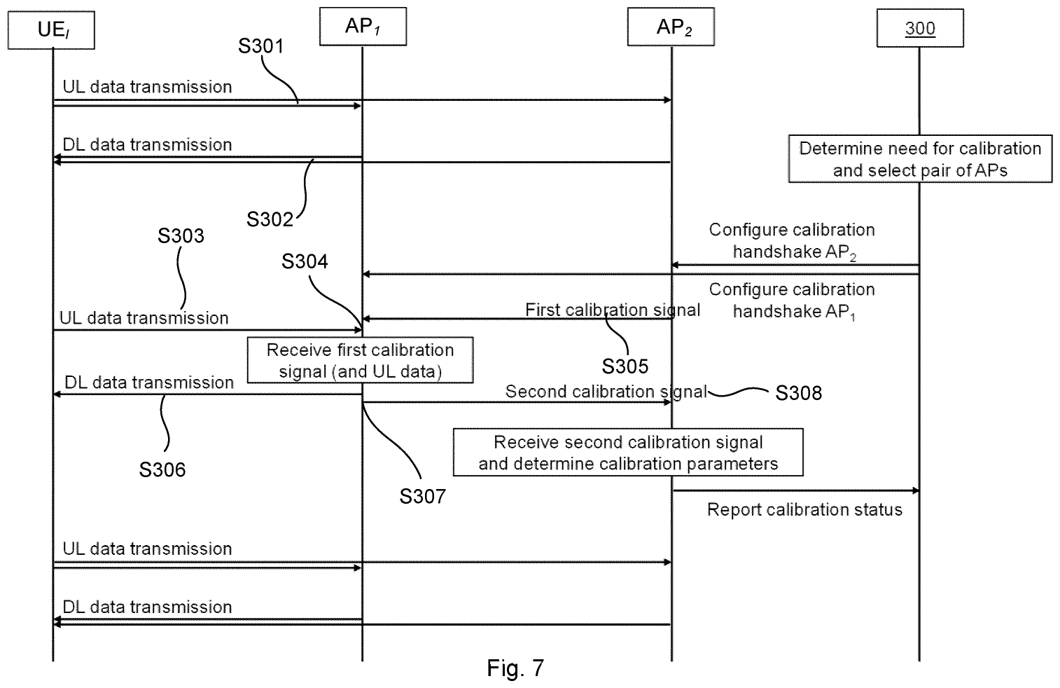

One particular embodiment for transmitting and/or receiving calibration reference signals between APs 200a: 200K and for estimating a phase difference between APs 200a: 200K in a D-MIMO network 100 operating in TDD mode based on at least some of the above disclosed embodiments will now be disclosed in detail with reference to the signalling diagram of FIG. 7.

During normal TDD uplink timeslots (step S301) and normal TDD DL timeslots (step S302) UEₗ is served by AP₁ and AP₂.

The centralized node 300 determines a need, or an opportunity, for a calibration procedure to be performed for the APs according to some previously described examples. The centralized node 300 further determines that the calibration procedure shall start in a TDD UL timeslot and that AP₂ shall first transmit a calibration reference signal.

In a subsequent TDD UL timeslot, the UE transmits UL user data (step S303). The UL user data is received by, and processed in, AP₁ (step S304) but not in AP₂. Instead of receiving the UL user data from the UE, AP₂ simultaneously transmits a first calibration reference signal targeting AP₁ (step S305). In addition to receiving the UL user data from the UE, AP₁ therefore also receives, and processes, the first calibration reference signal from AP₂. AP₁ then determines a second calibration reference signal to be transmitted back towards AP₂. The second calibration reference signal may be a standard reference signal, or a signal based on the received phase of the first calibration reference signal.

In a subsequent TDD DL timeslot, UE receives DL user data (step S306). AP₁ transmits both the DL user data towards the UE as well as the second calibration reference signal targeting AP₂ (step S307). AP₂ receives the second calibration reference signal (step S308) but does not simultaneously transmit any DL user data signal towards the UE.

Based on the received second calibration reference signal, AP₂ determines and applies calibration parameters (e.g. by considering the phase of the received second calibration reference signal). Optionally, a calibration report is generated and provided by AP₂ to the centralized node 300. The calibration report may e.g., contain information of the residual phase uncertainty (e.g. based on estimated signal-to-noise ratio of the calibration reference signal reception).

Exactly how AP₂ determines the calibration parameters depends on the specifics of the calibration procedure. Next follows one non-limiting example of a calibration procedure.

Assume that a first calibration signal is transmitted from AP₂ with a local reference phase of zero degrees.

Assume that the first reference signal is received by AP₁ with a local reference phase of θ₁ degrees. The value of θ₁ depends both on the phase rotation of the radio channel (denoted τ) and on the relative phase misalignment (denoted δ) between AP₁ and AP₂ (i.e., θ₁=τ+δ).

A second phase reference signal is transmitted from AP₁ with a local phase reference of −θ₁ degrees (i.e., the second reference signal is transmitted with the conjugate of the received phase of the first reference signal).

The second phase reference signal is received by AP₂ with a local phase reference of θ₂ degrees. Note that the value of θ₂ does not depend on the phase rotation of the radio channel (τ) but it only depends on the relative phase misalignment (δ) between AP₁ and AP₂ (i.e., θ₂=−2δ). The phase rotation caused by the channel is cancelled by the conjugate operation above. And the factor 2 comes from the fact that AP₁ does two operations using the local phase reference (receiving the first reference signals and transmitting the second reference signals).

AP₂ may now (in this example) determine the phase calibration parameter δ to be equal to −θ₂/2.

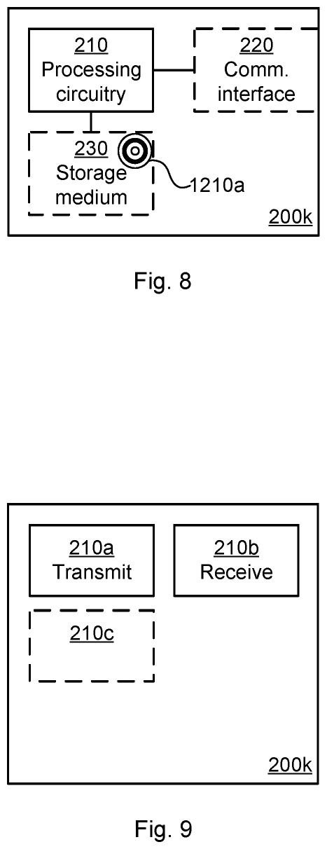

FIG. 8 schematically illustrates, in terms of a number of functional units, the components of an AP 200k according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1210a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the AP 200k to perform a set of operations, or steps, as disclosed above. For example, the storage medium 230 may store the set of operations, and the processing circuitry 210 may be configured to retrieve the set of operations from the storage medium 230 to cause the AP 200k to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The AP 200k may further comprise a communications interface 220 for communications with the served user equipment 130 and the centralized node 300, as well as with other APs. As such the communications interface 220 may comprise one or more transmitters and receivers, comprising analogue and digital components.

The processing circuitry 210 controls the general operation of the AP 200k e.g. by sending data and control signals to the communications interface 220 and the storage medium 230, by receiving data and reports from the communications interface 220, and by retrieving data and instructions from the storage medium 230. Other components, as well as the related functionality, of the AP 200k are omitted in order not to obscure the concepts presented herein.

FIG. 9 schematically illustrates, in terms of a number of functional modules, the components of an AP 200k according to an embodiment. The AP 200k of FIG. 9 comprises a number of functional modules; a transmit module 210a configured to perform step S102 as well as optional steps S104, S106, S110, and S112 and a receive module 210b configured to perform step S108. The AP 200k of FIG. 9 may further comprise a number of optional functional modules, as represented by functional module 210c. In general terms, each functional module 210a: 210c may be implemented in hardware or in software. Preferably, one or more or all functional modules 210a: 210c may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210c and to execute these instructions, thereby performing any steps of the AP 200k as disclosed herein.

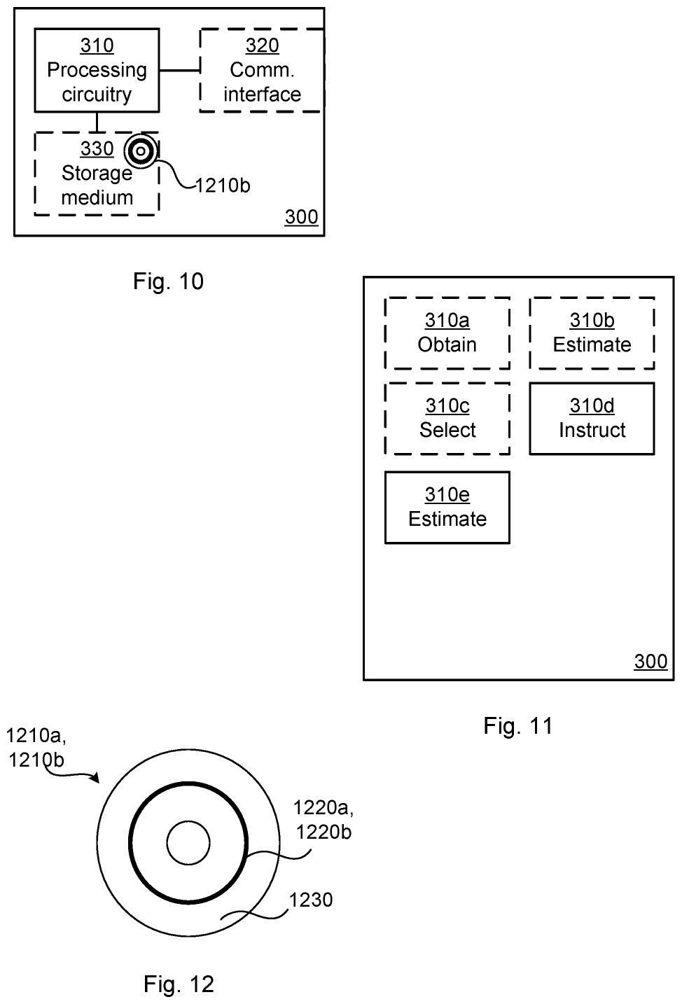

FIG. 10 schematically illustrates, in terms of a number of functional units, the components of a centralized node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1210b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the centralized node 300 to perform a set of operations, or steps, as disclosed above. For example, the storage medium 330 may store the set of operations, and the processing circuitry 310 may be configured to retrieve the set of operations from the storage medium 330 to cause the centralized node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The centralized node 300 may further comprise a communications interface 320 for communications with the APs 200a: 200K. As such the communications interface 320 may comprise one or more transmitters and receivers, comprising analogue and digital components.

The processing circuitry 310 controls the general operation of the centralized node 300 e.g. by sending data and control signals to the communications interface 320 and the storage medium 330, by receiving data and reports from the communications interface 320, and by retrieving data and instructions from the storage medium 330. Other components, as well as the related functionality, of the centralized node 300 are omitted in order not to obscure the concepts presented herein.

FIG. 11 schematically illustrates, in terms of a number of functional modules, the components of a centralized node 300 according to an embodiment. The centralized node 300 of FIG. 11 comprises a number of functional modules; an instruct module 310d configured to perform step S208, and an estimate module 310e configured to perform step S210. The centralized node 300 of FIG. 11 may further comprise a number of optional functional modules, such as any of an obtain module 310a configured to perform step S202, an estimate module 310b configured to perform step S204, and a select module 310c configured to perform step S206. In general terms, each functional module 310a: 310e may be implemented in hardware or in software. Preferably, one or more or all functional modules 310a: 310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310e and to execute these instructions, thereby performing any steps of the centralized node 300 as disclosed herein.

The centralized node 300 may be provided as a standalone device or as a part of at least one further device. For example, the centralized node 300 may be provided in a node of the radio access network or in a node of the core network. Alternatively, functionality of the centralized node 300 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the centralized node 300 may be executed in a first device, and a second portion of the instructions performed by the centralized node 300 may be executed in a second device; the herein disclosed embodiments are not limited to any particular number of devices on which the instructions performed by the centralized node 300 may be executed. Hence, the methods according to the herein disclosed embodiments are suitable to be performed by a centralized node 300 residing in a cloud computational environment. Therefore, although a single processing circuitry 210, 310 is illustrated in FIG. 10 the processing circuitry 310 may be distributed among a plurality of devices, or nodes. The same applies to the functional modules 310a: 310e of FIG. 11 and the computer program 1220b of FIG. 12.

FIG. 12 shows one example of a computer program product 1210a, 1210b comprising computer readable means 1230. On this computer readable means 1230, a computer program 1220a can be stored, which computer program 1220a can cause the processing circuitry 210 and thereto operatively coupled entities and devices, such as the communications interface 220 and the storage medium 230, to execute methods according to embodiments described herein. The computer program 1220a and/or computer program product 1210a may thus provide means for performing any steps of the AP 200k as herein disclosed. On this computer readable means 1230, a computer program 1220b can be stored, which computer program 1220b can cause the processing circuitry 310 and thereto operatively coupled entities and devices, such as the communications interface 320 and the storage medium 330, to execute methods according to embodiments described herein. The computer program 1220b and/or computer program product 1210b may thus provide means for performing any steps of the centralized node 300 as herein disclosed.

In the example of FIG. 12, the computer program product 1210a, 1210b is illustrated as an optical disc, such as a CD (compact disc) or a DVD (digital versatile disc) or a Blu-Ray disc. The computer program product 1210a, 1210b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1220a, 1220b is here schematically shown as a track on the depicted optical disk, the computer program 1220a, 1220b can be stored in any way which is suitable for the computer program product 1210a, 1210b.

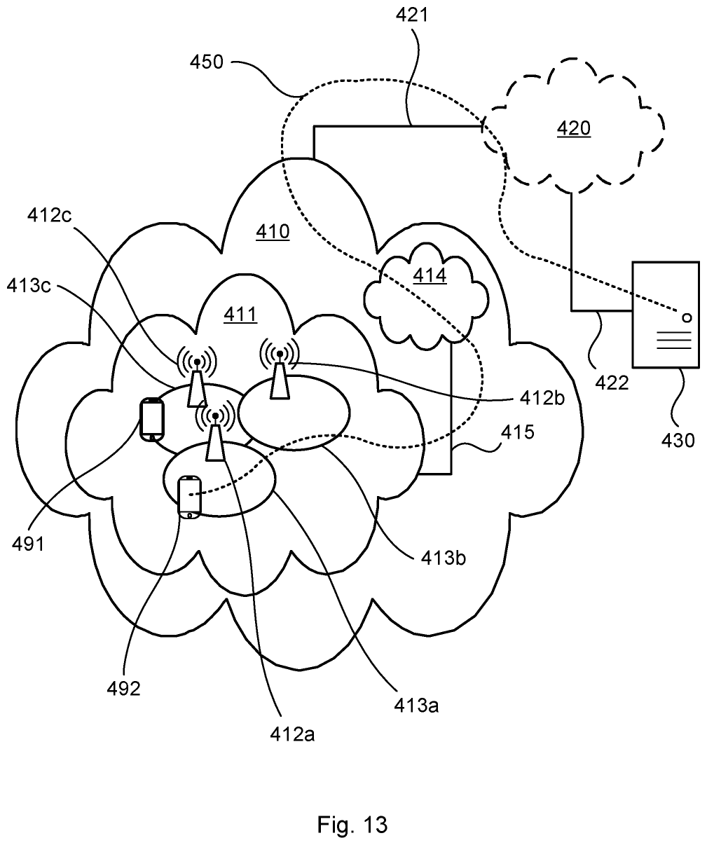

FIG. 13 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as defined by the APs 200a: 200K in FIG. 3, and core network 414, such as interfaced by the centralized node 300 in FIG. 4. Access network 411 comprises a plurality of radio access network nodes 412a, 412b, 412c, such as NBs, eNBs, gNBs (each corresponding to the APs 200a: 200K in FIG. 3) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 130 of FIG. 3.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

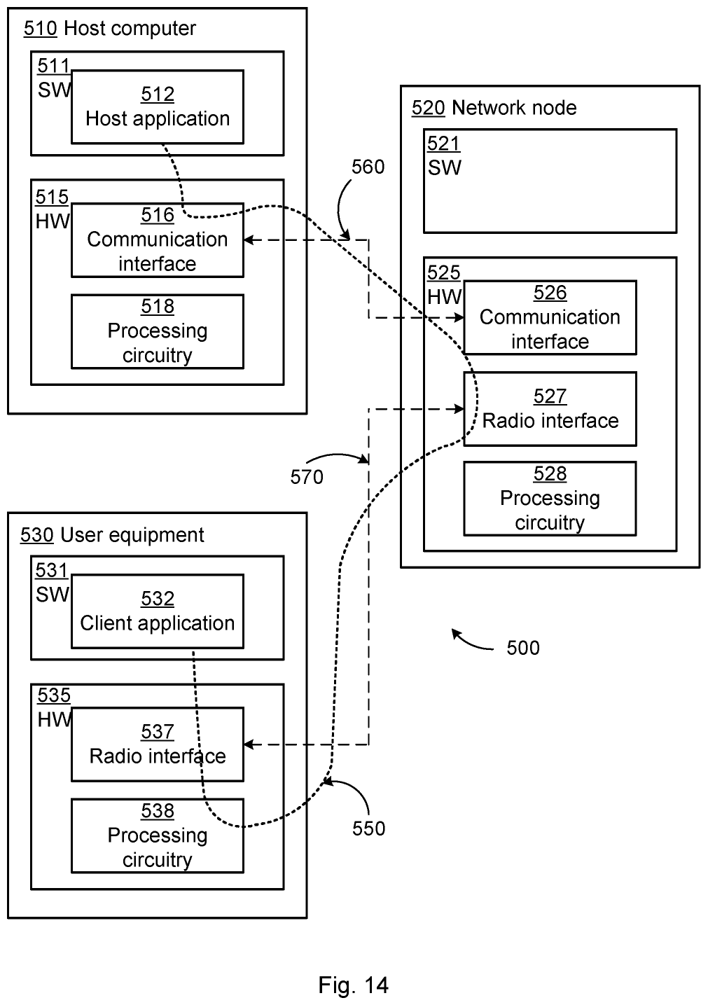

FIG. 14 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 130 in FIG. 3. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the APs 200a: 200K in FIG. 3. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by radio access network node 520. Communication interface 526 may be configured to facilitate connection 560 to host computer 510. Connection 560 may be direct or it may pass through a core network (not shown in FIG. 14) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 14 may be similar or identical to host computer 430, one of network nodes 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for one or both transmitting and receiving calibration reference signals between access points, APs, in a distributed multiple input multiple output, D-MIMO, network operating in time division duplex, TDD, mode, the method comprising one or both:
transmitting, by a first AP and towards a second AP, a first calibration reference signal in a first uplink timeslot whilst the first AP refrains from receiving user data in the first uplink timeslot when transmitting the first calibration reference signal; and
receiving, by a third AP and from a fourth AP, a second calibration reference signal in a first downlink timeslot whilst the third AP refrains from transmitting user data in the first downlink timeslot when receiving the second calibration reference signal.

2. The method according to claim 1, further comprising:
transmitting, by the second AP, a third calibration reference signal towards the first AP and user data towards user equipment served in the D-MIMO network in a second downlink timeslot following the first uplink timeslot.

3. The method according to claim 2, further comprising:
transmitting, by the second AP and towards the first AP, a fifth calibration reference signal in the first uplink timeslot whilst the second AP refrains from receiving user data in the first uplink timeslot when transmitting the third calibration reference signal.

4. The method according to claim 3, further comprising:
transmitting, by the third AP and towards the fourth AP, a fourth calibration reference signal in a second uplink timeslot following the first downlink timeslot whilst the third AP refrains from receiving user data in the second uplink timeslot when transmitting the fifth calibration reference signal.

5. The method according to claim 1, further comprising:
transmitting, by the third AP, a sixth calibration reference signal towards the fourth AP and user data towards user equipment served in the D-MIMO network in the first downlink timeslot.

6. The method according to claim 1, wherein the first AP and the third AP is one and the same AP, and wherein the third AP and the fourth AP is one and the same AP.

7. The method according to claim 3, wherein one or both:
the third calibration reference signal and the user data are beamformed differently; and
the fourth calibration reference signal and the user data are beamformed differently.

8. The method according to claim 3, wherein one or both:
the third calibration reference signal and the user data are transmitted in a same time/frequency resources; and
the fourth calibration reference signal and the user data are transmitted in the same time/frequency resources.

9. The method according to claim 1, wherein one or more of:
in the first uplink timeslot the second AP receives the first calibration reference signal as well as user data from user equipment served by the second AP, and wherein the first calibration reference signal and the user data are spatially multiplexed at the second AP; and
in the first uplink timeslot the first AP receives the third calibration reference signal as well as user data from user equipment served by the first AP, and wherein the third calibration reference signal and the user data are spatially multiplexed at the first AP; and
in the second uplink timeslot the fourth AP receives the fourth calibration reference signal as well as user data from user equipment served by the fourth AP, and wherein the fourth calibration reference signal and the user data are spatially multiplexed at the fourth AP.

10. The method according to claim 1, wherein the respective calibration reference signals are transmitted and processed upon the APs having received instructions from a centralized node in the D-MIMO network to do so.

11. A method for estimating a phase difference between access points, APs, in a distributed multiple input multiple output, D-MIMO, network operating in time division duplex, TDD, mode, the method being performed by a centralized node in the D-MIMO network, the method comprising:
instructing the APs to perform bi-directional sounding for the centralized node to obtain measurements on calibration reference signals by the APs wirelessly exchanging the calibration reference signals with each other, one or both:
a first AP is being instructed to transmit a first calibration reference signal in a first uplink timeslot towards a second AP and to refrain from receiving user data in the first uplink timeslot when transmitting the first calibration reference signal; and
a third AP being instructed to receive a second calibration reference signal in a first downlink timeslot from a fourth AP and to refrain from transmitting user data in the first downlink timeslot when receiving the second calibration reference signal; and
estimating the phase difference between one or both of:
the first AP and the second AP; and
the third AP and the fourth AP,
from measurements made on one or both of the first calibration reference signal and the second calibration reference signal.

12.-16. (canceled)

17. The method according to claim 11, further comprising:
obtaining system state parameters for the APs, wherein one or both:
between which of the APs the first calibration reference signal is to be transmitted; and
between which of the APs the second calibration reference signal is to be transmitted,
is determined as a function of the system state parameters.

18. The method according to claim 17, wherein the system state parameters pertain to any, or any combination of:
traffic situation per each of the APs,
phase calibration between pairs of the APs,
channel state information per each of the APs, and
modulation and coding scheme used per each of the APs.

19. The method according to claim 11,
wherein one or both:
between which of the APs the first calibration reference signal is to be transmitted; and
between which of the APs the second calibration reference signal is to be transmitted,
is jointly determined together with determining scheduling of user data traffic for the APs.

20. The method according to claim 11, further comprising:
estimating radio channel properties between the APs and user equipment served by the APs; and
selecting one or both:
which of the APs to transmit the first calibration reference signal; and
which of the APs to receive the second calibration reference signal, as a function of the radio channel properties.

21. (canceled)

22. The method according to claim 11, wherein which of the APs to be instructed to transmit the first calibration reference signal in the first uplink timeslot is by the centralized node selected as the AP with lowest channel quality towards user equipment served in the D-MIMO network.

23. The method according to claim 11, wherein which of the APs to be instructed to receive the second calibration reference signal in the first downlink timeslot is by the centralized node selected as one of the APs with a channel quality below a threshold value towards user equipment served in the D-MIMO network.

24. The method according to claim 11, wherein which of the APs to be instructed to transmit the first calibration reference signal in the first uplink timeslot is by the centralized node selected as one of the APs with a channel quality below a threshold value towards user equipment served in the D-MIMO network.

25. An access point, AP, for transmitting and/or receiving calibration reference signals in a distributed multiple input multiple output, D-MIMO, network operating in time division duplex, TDD, mode, the AP comprising processing circuitry, the processing circuitry being configured to cause the AP to one or both:
transmit, towards a second AP, a first calibration reference signal in a first uplink timeslot whilst refraining from receiving user data in the first uplink timeslot when transmitting the first calibration reference signal; and
receive, from a fourth AP, a second calibration reference signal in a first downlink timeslot whilst refraining from transmitting user data in the first downlink timeslot when receiving the second calibration reference signal.

26. (canceled)

27. (canceled)

28. A centralized node for estimating a phase difference between access points, APs, in a distributed multiple input multiple output, D-MIMO, network operating in time division duplex, TDD, mode, the centralized node comprising processing circuitry, the processing circuitry being configured to cause the centralized node to:
instruct the APs to perform bi-directional sounding for the centralized node to obtain measurements on calibration reference signals by the APs wirelessly exchanging the calibration reference signals with each other, one or both:
a first AP being instructed to transmit a first calibration reference signal in a first uplink timeslot towards a second AP and to refrain from receiving user data in the first uplink timeslot when transmitting the first calibration reference signal; and
a third AP being instructed to receive a second calibration reference signal in a first downlink timeslot from a fourth AP and to refrain from transmitting user data in the first downlink timeslot when receiving the second calibration reference signal; and
estimate the phase difference the phase difference between one or both of:
the first AP and the second AP; and
the third AP and the fourth AP,
from measurements made on one or both of the first calibration reference signal and the second calibration reference signal.

29.-34. (canceled)
